(19) United States
(12) Patent Application Publication
(10) Pub. No.: US 2015/0202782 A1
(43) Pub. Date: Jul. 23, 2015

(54) ELECTROMOTIVE HAIR CUTTER

(71) Applicant: PO - HSUN CHIEN, Kaohsiung Hsien (TW)

(72) Inventor: PO - HSUN CHIEN, Kaohsiung Hsien (TW)

(21) Appl. No.: 14/161,696

(22) Filed: Jan. 23, 2014

(51) Int. Cl. B26B 19/04

(52) U.S. Cl. CPC B26B 19/04

(57) ABSTRACT

An electromotive hair cutter includes a retaining knife; an upper front side of the retaining knife being formed with a plurality of inclined slots with different slopes; the depths of the slots being different; a lower side of each slot being formed as a downward inclined surface; a rear upper side of the retaining knife being attached with an upper substrate; an upper side of the upper substrate protruded upwards from an upper edge of the retaining knife so that the slot surface of the slot and the upper substrate being formed with different angles; two lower substrate being formed from a lower rear side of the retaining knife; wherein the upper substrate and the lower substrate are detachable from the retaining knife.

The present invention is a continuation in part (CIP) of U.S. patent application Ser. No. 12/631,871, which is assigned to the applicant and inventor of the present invention. Thus the contents of the U.S. patent application Ser. No. 12/631,871 is incorporated into the present invention as a part of the present invention.

### FIELD OF THE INVENTION

The present invention relates to hair cutters, and particularly to an electromotive hair cutter, which provides a plurality of cutting slots at a front edge of a retaining knife of the electromotive hair cutter. The cutting slots have different depths and slopes so as to cut hairs with different lengths. The arrangement of the slopes and depths of the cutting slots may be regular or irregular.

### BACKGROUND OF THE INVENTION

A general electromotive hair cutter for cutting hair has a retaining knife and a movable knife which can move rightwards and leftwards for cutting hair. In the retaining knife, a front edge of the retaining knife has a plurality of teeth. Cutting slots are formed between the teeth. The depths of the cutting slots are identical. However this structure will make the hairs cut have the same length so as to have an ordered hair shapes, but this is not suitable for many some special usages.

### SUMMARY OF THE INVENTION

Accordingly, the object of the present invention is to provide an electromotive hair cutter, which provides a plurality of cutting slots at a front edge of a retaining knife of the electromotive hair cutter. The cutting slots have different depths and slopes so as to cut hairs with different lengths. The arrangement of the slopes and depths of the cutting slots may be regular or irregular.

To achieve above object, the present invention provides an electromotive hair cutter includes a retaining knife; an upper front side of the retaining knife being formed with a plurality of inclined slots with different slopes; the depths of the slots being different; a lower side of each slot being formed as a downward inclined surface; a rear upper side of the retaining knife being attached with an upper substrate; an upper side of the upper substrate protruded upwards from an upper edge of the retaining knife so that the slot surface of the slot and the upper substrate being formed with different angles; two lower substrate being formed from a lower rear side of the retaining knife; wherein the upper substrate and the lower substrate are detachable from the retaining knife.

The various objects and advantages of the present invention will be more readily understood from the following detailed description when read in conjunction with the appended drawing.

### BRIEF DESCRIPTION OF THE DRAWINGS

FIG. 1 shows an elevation view of the prototype of the retaining knife according to the present invention.

FIG. 2 is a cross sectional view along line 2-2 of FIG. 1.

FIG. 3 is a cross sectional view along line 3-3 of FIG. 1.

FIG. 4 is a cross sectional view along line 4-4 of FIG. 1.

FIG. 5 is an elevation view of the retaining knife in the present invention.

FIG. 6 is a cross sectional view along line 6-6 of the present invention.

FIG. 7 is a cross sectional view along line 7-7 of the present invention.

FIG. 8 is a cross sectional view along line 8-8 of the present invention.

FIG. 9 is a schematic view showing the application of the present invention, wherein retaining knife is used with a movable knife which is at a front section of an electromotive hair cutter.

FIG. 10 is a schematic view showing the application of the present invention, wherein retaining knife is used with a movable knife which is at a middle section of an electromotive hair cutter.

FIG. 11 is a schematic view showing the application of the present invention, wherein retaining knife is used with a movable knife which is at a rear section of an electromotive hair cutter.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

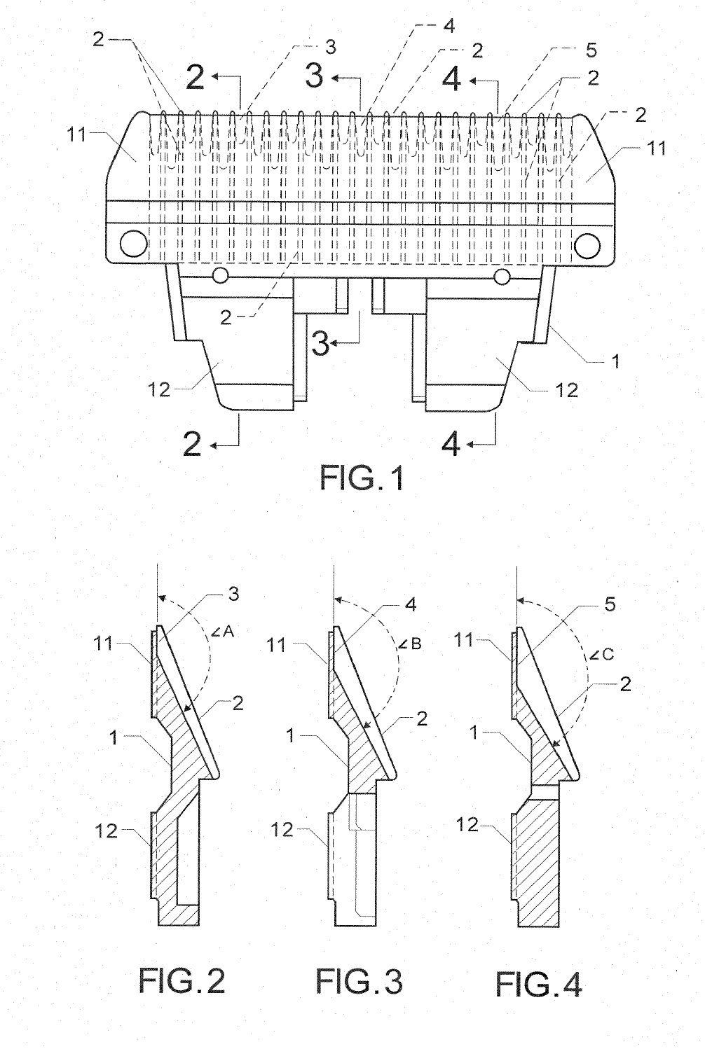

Referring to FIG. 1, the electromotive hair cutter according to the present invention is illustrated. The hair cutter of the present invention includes a retaining knife 1 which is made by molding injection of metal powder (referring to FIGS. 1 to 4). An upper front side of the retaining knife 1 is formed with a plurality of inclined slots 3, 4, and 5 with different slopes. The depths of the slots 3, 4, and 5 arc different. In the drawing, there are three kinds of depths are shown. A lower side of each slot 3, 4, and 5 is formed as a downward inclined surface 2 as illustrated in FIGS. 2, 3, and 4. A rear upper side of the retaining knife 1 is attached with an upper substrate 11. An upper side of the upper substrate 11 protruded upwards from an upper edge of the retaining knife 1 so that the slot surface of the slot 2 and the upper substrate 11 are formed with different angles (<A), (<B), (<C). Two lower substrate 12 are formed from a lower rear side of the retaining knife 1.

The number of different slots are not confined to three as illustrated in the drawings. The number of slots may be 2, 3, 4, and others as desired.

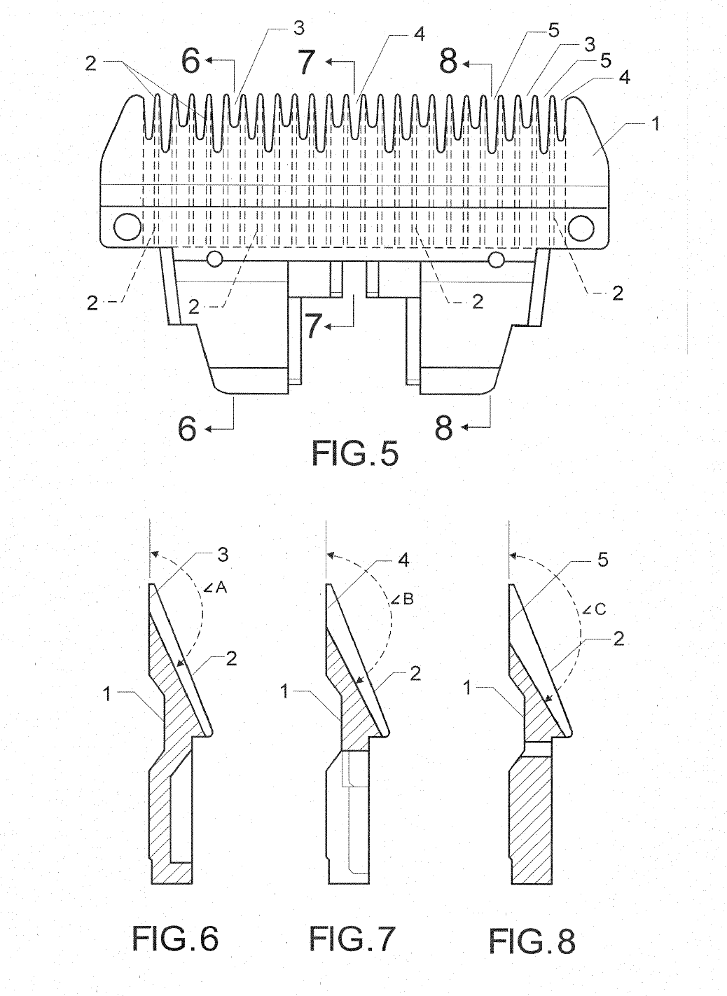

Referring to FIGS. 5 to 8, it is illustrated that in use, the upper substrate 11 and lower substrate 12 are cut away so as to protrude the teeth 12 with cutting slots 3, 4, 5 of different depths.

The arrangement of the cutting slots 3, 4, 5 with different slopes (<A), (<B), (<C) is regular or irregular. In the drawing the slopes of the (<A), (<B), (<C) are different, however at least two different slopes arc necessary according to the present invention.

The retaining knife 1 of the present invention is used with an electromotive hair cutter in a position for retaining a movable knife. The electromotive hair cutter has different adjustable stages. Thus, the movable knife can be suitable to one of the cutting slots of different depth for cutting. Thus hairs of different lengths can be cut to have desired shape.

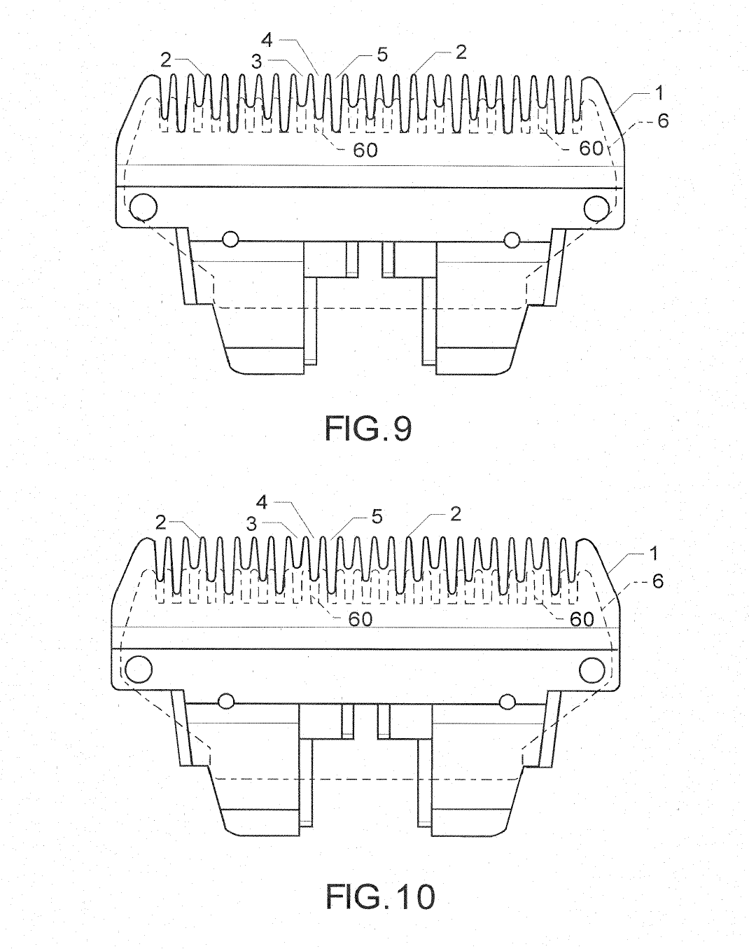

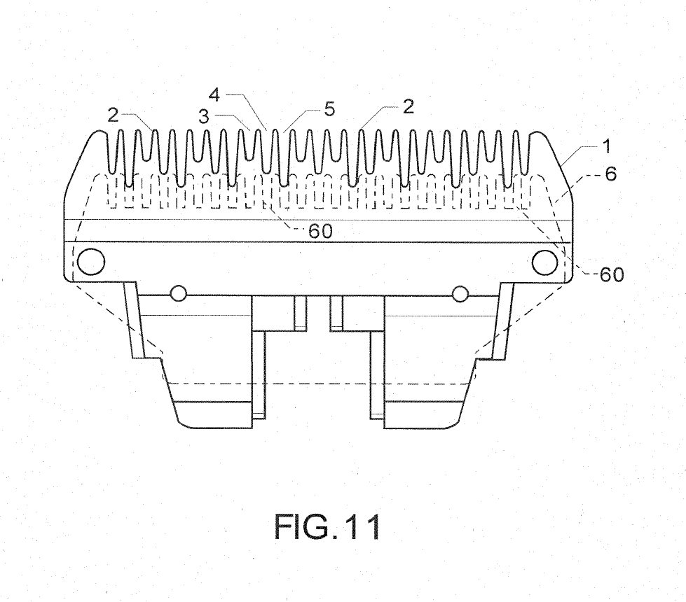

Referring to FIGS. 9 and 11, the use of the present invention is illustrated. In FIG. 9, the movable knife 6 is adjusted to be at a front section. The teeth 60 of the movable knife 6 can cut hairs in the cutting slots 3, 4, 5 between the teeth 2 of the retaining knife 1.

Referring to FIG. 10, the movable knife 6 is adjusted to be at a middle section, the teeth 60 of the movable knife 6 cannot cut the hairs in the cutting slot 3 of the retaining knife 1, but it can cut the hairs in the cutting slots 4 and 5.

In FIG. 11, it is illustrated that the movable knife 6 is adjusted to be at a rear section, the teeth 60 of the movable knife 6 cannot cut hairs in the cutting slots 3, 4 of the retaining knife 1, but it can cut hairs in the cutting slot 5.

Thus, in the present invention, by the cutting slots 3, 4, 5 of different depths between the teeth 2 of the retaining knife 1, and by adjusting the movable knife 6 to be at different section of the electromotive hair cutter, the movable knife 6 cut hairs in cutting slots 3, 4, 5, or hairs in the cutting slots 4, 5 or hairs in cutting slot 5 to as to achieve the object of cutting hairs of different lengths and to have a desired shape.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An electromotive hair cutter comprising:
a retaining knife (1); an upper front side of the retaining knife (1) being formed with a plurality of inclined slots with different slopes; the depths of the slots (3, 4, 5) being different; a lower side of each slot (3, 4, 5) being formed as a downward inclined surface (2); a rear upper side of the retaining knife being attached with an upper substrate; an upper side of the upper substrate protruded upwards from an upper edge of the retaining knife so that the slot surface of the slot (3, 4, 5) and the upper substrate (11) being formed with different angles (<A), (<B), (<C); two lower substrate (12) being formed from a lower rear side of the retaining knife (1);
wherein the upper substrate (11) and the lower substrate (12) are detachable from the retaining knife (1).

2. The electromotive hair cutter as claimed in claim 4, wherein the arrangement of the cutting slots with different slopes is regular or irregular.

3. The electromotive hair cutter as claimed in claim 1, wherein there are at least two different kinds of slots which have different depths.

3. The electromotive hair cutter as claimed in claim 1, wherein there are at least two different kinds of slots which have different depths.
